(19) United States
(12) Patent Application Publication
(10) Pub. No.: US 2012/0259864 A1
(43) Pub. Date: Oct. 11, 2012

(54) OPTIMIZATION OF WORK SITE UTILIZATION

(75) Inventors: William C. Jetton, Charlotte, NC (US); Thomas R. Kurtz, Charlotte, NC (US); Glenn McNairy, Charlotte, NC (US); Benjamin T. Teal, Charlotte, NC (US)

(73) Assignee: BANK OF AMERICA CORPORATION, Charlotte, NC (US)

(21) Appl. No.: 13/081,292

(22) Filed: Apr. 6, 2011

(51) Int. Cl. G06F 17/30

(52) U.S. Cl. 707/748; 707/E17.084

(57) ABSTRACT

Embodiments of the invention provide for optimizing work site utilization within a business entity or the like. Work site optimization is realized by ranking a predetermined group of leased work sites relative to their feasibility for exiting and making decisioning based on the rankings. The ranking is based on an automated and qualitative scoring of the work sites. Additionally, embodiments of the invention account for the potential use of off-work site employees and, as such, the optimization rankings that are provided serve to predict future work site needs.

### FIELD

In general, embodiments herein disclosed relate to business planning and, more specifically, optimizing utilization of work sites by ranking a predetermined group of work sites relative to their feasibility for exiting.

### BACKGROUND

In many corporate environments the need exists to insure that work site utilization is optimized. For example, if multiple works exist within a geographic region that each have a high degree of vacancy, the opportunity may exist to reduce the number of work sites and consolidate personnel amongst the work sites that remain in operation. Such work site reduction and consolidation provides for significant opportunities for the corporation or other entity to reduce operating costs.

The need for work site reduction and consolidation is frequently evident when corporations/entities merge because, in many instances, the merger results in unnecessary duplication of personnel/job efforts. However, work site reduction and consolidation is not limited to the merger scenario and is especially prominent in businesses which may be impacted by changes in the economy and, therefore, experience a high degree of volatility. For example, recently the mortgage industry has experienced a highly volatile period in which mortgage activity has sharply declined resulting in a drop off in the number of mortgage loan officers. Such a drastic decline in mortgage activity and mortgage loan officers resulted in an oversized work site platform for the existing workforce.

In addition, work site reduction and consolidation is being fueled by the flight of employees from the work site to a “mobile” or “home” office environment. In the “mobile” or “home” office environment the employee does not have an assigned work space at a work site and, as such, as more and more employees become transient less work site space is needed by the business entity. The “mobile” or “home” office employee is highly attractive to the business entity as less work site space equates to lower overhead costs. Therefore, in many businesses, if the job function of the employee lends itself to the “mobile” or “home” office environment, the business entity is likely to prefer and/or encourage the employees to consider such an alternative work environment.

The current process for work site reduction and consolidation is manual in nature and, as such, is an inaccurate, inefficient and labor intensive process. The process typically requires property managers or the like to make site visits to assess the current utilization of work sites. In addition, typically numerous meeting and/or electronic communications are required prior to management making decisions on which sites should be exited. Such work site visits, meetings and the like are time consuming efforts that add to the overall costs associated with work site reduction and consolidation. In addition, decisions resulting from the manual process are often subjective in nature, which rely on management's personal and/or business interests and, therefore, may not be the most prudent decisions from a cost reduction standpoint.

Therefore, a need exists to develop methods, systems, computer program products and the like which provide for a highly automated and systematic approach to making work site reduction and consolidation decisions. In addition, the desired methods, systems and computer program products should provide a quantitative, objective approach to work site reduction and consolidation decisioning, so as to limit the amount of subjective involved in current decision processing. Moreover, the desired methods, systems and computer program products should be predictive, in that, embodiments should take into account the potential for off-work site employees (i.e., “mobile” or “home” office employees) in making work site reduction and consolidation decisions. The desired embodiments should take into account all scenarios in which work site reduction and consolidation are needed, such as a merger environment, a highly volatile environment, a business-as-usual environment or the like.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, systems and computer program products are defined that provide for optimizing work site utilization within a business entity or the like. Specific embodiments of the invention provide for realizing such optimization by ranking a predetermined group of leased work sites relative to their feasibility for exiting. The ranking is based on an automated and qualitative scoring of the work sites, which eliminates the subjectivity inherent in current manual decision processes. The automated, systematic and qualitative approach of the present invention provides for a more efficient means for work site reduction and consolidation decisioning, in which decisions can be made with limited management involvement and with the assurance that the most cost effective decision is being pursued. Additionally, the embodiments herein described account for the potential use of off-work site employees (e.g., “mobile” or “home” office employees or the like) and, as such, the optimization rankings that are provided serve to predict future work site needs. In addition, the methods, systems and computer program products described herein are adaptable to any environment that may require work site reduction analysis, such as a merger environment, a highly volatile environment, a business-as-usual environment or the like.

A method for optimizing work site utilization provides for first embodiments of the invention. The method includes receiving, via a computing device, one or more user inputs that each define work site criterion and identifying, via a computing device processor, a plurality of work sites based on the received inputs>The method further includes determining, via a computing device processor, an exit ranking for the plurality of work sites. The exit ranking is relative to a feasibility to exit a lease associated with a work site.

In specific embodiments of the method, receiving further includes receiving, via the computing device, the one or more user inputs that each define work site criterion. The work site criterion is one of (1) a hierarchy within the business, (2) a date range for occurrence of a lease event, (3) a work site size, (4) a geographical area or (5) an employee work function.

In other specific embodiments of the method, determining further includes determining, via the computing device processor, the exit ranking for the plurality of work sites, wherein the exit ranking is based on a plurality exit attributes. In such embodiments, the exit attributes may take into account potential use of off-work site employees, otherwise referred to as remote or mobile employees. In such the embodiments of the method, the exit attributes may specifically include one or more of (1) number of “drop-in” work sites within a geographical area, (2) off-work site employee adoption rate for a work site, or (3) off-work site employee eligibility rate for a work site. In additional embodiments of the method, the exit attributes may additionally include one or more of (1) percentage of work site allocation controlled by a hierarchy, (2) size of work site, (3) off-work site employee eligibility rate for a work site, (4) number of sub-hierarchies with a hierarchy for a work site, or (5) total employees for a hierarchy.

In still further specific embodiments of the method, determining further includes determining, via the computing device processor, the exit ranking for the plurality of work sites. The exit ranking is based on an exit score that is calculated by a weighted average of the plurality exit attributes. In such embodiments, the weighting may be based on a comparison of importance between each pair of exit attributes, such as through implementation of an Analytical Hierarchy Process (AHP), or the like.

In additional embodiments the method may include determining, via a computing device processor, a receiving ranking for a plurality of work sites, wherein the receiving ranking is relative to feasibility of a work site to receive employees from an exit work site. In such embodiments, the receiving ranking may be based on vacancy at each of the plurality of work sites and distance between the plurality of work sites.

An apparatus for optimizing work site utilization within a business, defines second embodiments of the invention. The apparatus includes a computing platform having at least one processor and a memory in communication with the processor>the apparatus further includes a work site optimization application stored in the memory, executable by the processor and including a work site drill down routine configured to receive one or more user inputs that each define work site criterion and identify a plurality of work sites based on the received inputs. The application further includes a work site exit ranking routine configured to determine an exit ranking for the plurality of work sites. The exit ranking is relative to a feasibility to exit a lease associated with a work site.

In specific embodiments of the apparatus, the work site drill down routine is further configured to receive the one or more user inputs that each define work site criterion. The work site criterion is one of (1) a hierarchy within the business, (2) a date range for occurrence of a lease event, (3) a work site size, (4) a geographical area or (5) an employee work function.

In further specific embodiments of the apparatus, the work site exit ranking routine is further configured to determine the exit ranking for the plurality of work sites, wherein the exit ranking is based on a plurality exit attributes. In specific embodiments of the apparatus, the exit attributes may take into account potential use of off-work site employees. In such embodiments of the apparatus, the exit attributes may include one or more of (1) number of “drop-in” work sites within a geographical area, (2) off-work site employee adoption rate for a work site or (3) off-work site employee eligibility rate for a work site. In further embodiments, the exit attributes may further include one or more of (1) percentage of work site allocation controlled by a hierarchy, (2) size of a work site, (3) off-work site employee eligibility rate for a work site, (4) number of sub-hierarchies with a hierarchy for a work site, or (5) total employees for a hierarchy.

Moreover, in further embodiments of the apparatus, the work site exit ranking routine is further configured to determine the exit ranking for the plurality of work sites, wherein the exit ranking is based on an exit score that is calculated by a weighted average of the plurality exit attributes. In such embodiments of the apparatus, the weighting may be based on a comparison of importance between each pair of exit attributes, such as by implementing an Analytical Hierarchy Process (AHP), or the like.

In further specific embodiments of the apparatus, the work site exit ranking routine is further configured to determine a receiving ranking for a plurality of work sites. In such embodiments of the apparatus, the receiving ranking is relative to a feasibility of a work site to receive employees from an exit work site. In further such embodiments of the apparatus, the receiving ranking is based on vacancy at each of the plurality of work sites and distance between the plurality of work sites.

A computer program product including a non-transitory computer-readable medium provides for third embodiments of the invention. The computer-readable medium includes a first set of codes for causing a computer to receive one or more user inputs that each define work site criterion and a second set of codes for causing a computer to identify a plurality of work sites based on the received inputs. The computer-readable medium additionally includes a third set of codes for causing a computer to determine an exit ranking for the plurality of work sites. The exit ranking is relative to a feasibility to exit a lease associated with a work site.

Thus, present embodiments described in greater detail below include systems, methods, and computer program products that provide for optimizing work site utilization within a business entity or the like. Specifically, as detailed below embodiments of the invention provide for realizing such optimization by ranking a predetermined group of leased work sites relative to their feasibility for exiting. In specific embodiments, the ranking is based on an automated and qualitative scoring of the work sites.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of an apparatus configured for work site utilization optimization, in accordance with one embodiment of the present invention;

FIG. 2 is more detailed block diagram of an apparatus configured for work site utilization optimization, in accordance with one embodiment of the present invention;

FIG. 3 is a flow diagram of a method for work site utilization optimization, in accordance with an embodiment of the present invention; and

FIGS. 4-8 are user interfaces implemented in a work site optimization application, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for optimizing work site utilization within a business entity or the like. Specific embodiments of the invention provide for realizing such optimization by ranking a predetermined group of leased work sites relative to their feasibility for exiting. The ranking is based on an automated and qualitative scoring of the work sites. The embodiments herein described in detail eliminate the subjectivity inherent in current manual decisioning processes. The automated, systematic and qualitative approach of the present invention provides for a more efficient means for work site exiting (i.e., reduction) and consolidation decisioning, in which decisions can be made with limited management involvement and with the assurance that the most cost effective decision is being pursued. Additionally, the embodiments herein described account for the potential use of off-work site employees (e.g., “mobile” or “home” office employees or the like) and, as such, the optimization rankings that are provided serve to predict future work site needs.

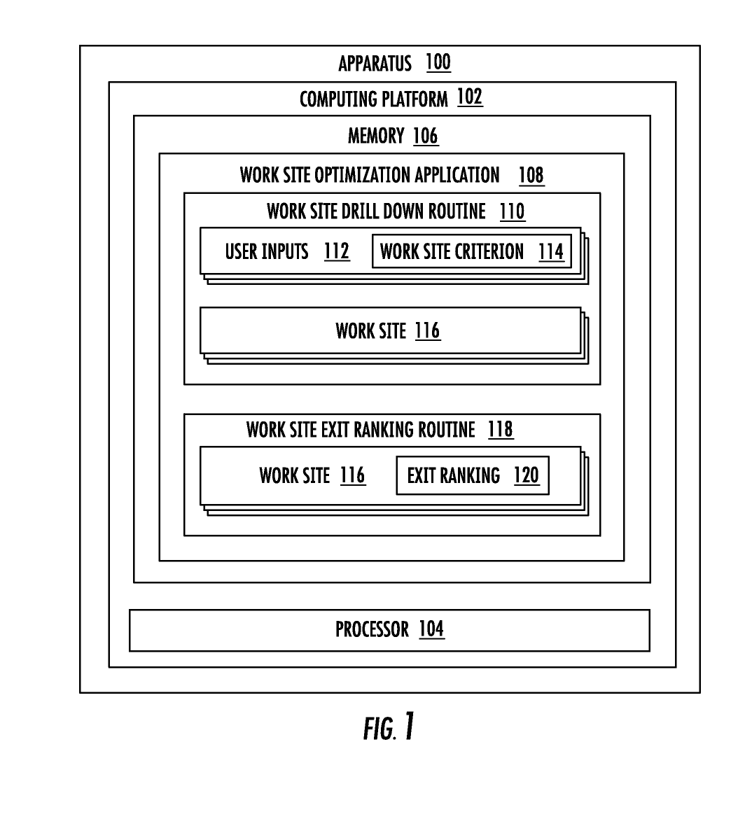

Referring to FIG. 1, a block diagram is depicted of an apparatus 100 configured to provide for work site utilization optimization within a business or other entity that implements numerous work sites. For the purposes of this disclosure the term “work site” includes any work space, such as a building, physical area or the like which employees, contractors or other individuals associated with a business or entity typically conduct their business, work assignment or other function. The apparatus 100 includes a computing platform 102 having at least one processor 104 and a memory 106 in communication with the processor 104.

The memory 106 of apparatus 100 stores work site optimization application 108, which is uniquely configured to determine work site utilization optimization. In specific embodiments of the invention work site utilization optimization is based on a determination of which existing work sites are more feasible to exit (i.e., permanently or temporarily close the work site and relocate the employees). In other specific embodiments of the invention, the work sites that are considered for work site utilization optimization are limited to those work sites that are leased by the business or entity. However, in other embodiments of the invention the work sites that may be considered for work sites utilization optimization may be limited to work sites that are owned by the business or a combination of work sites that are both leased and owned by the business.

In a specific embodiment of the invention, the work site optimization application 108 includes work site drill down routine 110 that is configured to allow a user to define a subset of the overall work site population for subsequent work site optimization consideration. As such, work site drill down routine 110 is configured to receive one or more, and typically a plurality of, user inputs 112 that each define work site criterion 114. As discussed in more detail below, the work site criterion may include, but is not limited to, a hierarchy within the business, a date range for occurrence of a contractual event, a work site size limitation, a geographical area limitation, an employee work function or the like. Based on the work site criterion 114, a plurality of work sites 116 is identified. The plurality of work sites 116 is a subset of the overall work site population and form the group of work sites considered for work site utilization optimization.

The work site optimization routine 118 additionally includes work site ranking routine 118 that is configured to determine an exit ranking 120 for each of the plurality work sites 116 identified in the work site drill down routine 110. In specific embodiments of the invention, the exit ranking 120 is relative to a feasibility to exit a work site and, more specifically, exit a lease associated with a work site. Such an exit ranking 120 provides work sire decisioning personnel with a quantitative assessment of which work sites should be considered for exiting. The quantitative nature of the process eliminates the subjectivity in determining which work sites to exit. In addition, the automated process whereby the work sites 116 that meet the necessary criterion 114 are identified in a matter of moments as opposed to days, weeks, months or the like and a subsequent instantaneous exit ranking 120 is provided, results in a highly efficient process for assessing exit strategies. The automated nature of the process provides for the exit analysis to be performed on a recurring schedule, such as each quarter or the like, thereby assuring that the business or entity is making timely and accurate decisions concerning which work sites utilization optimization.

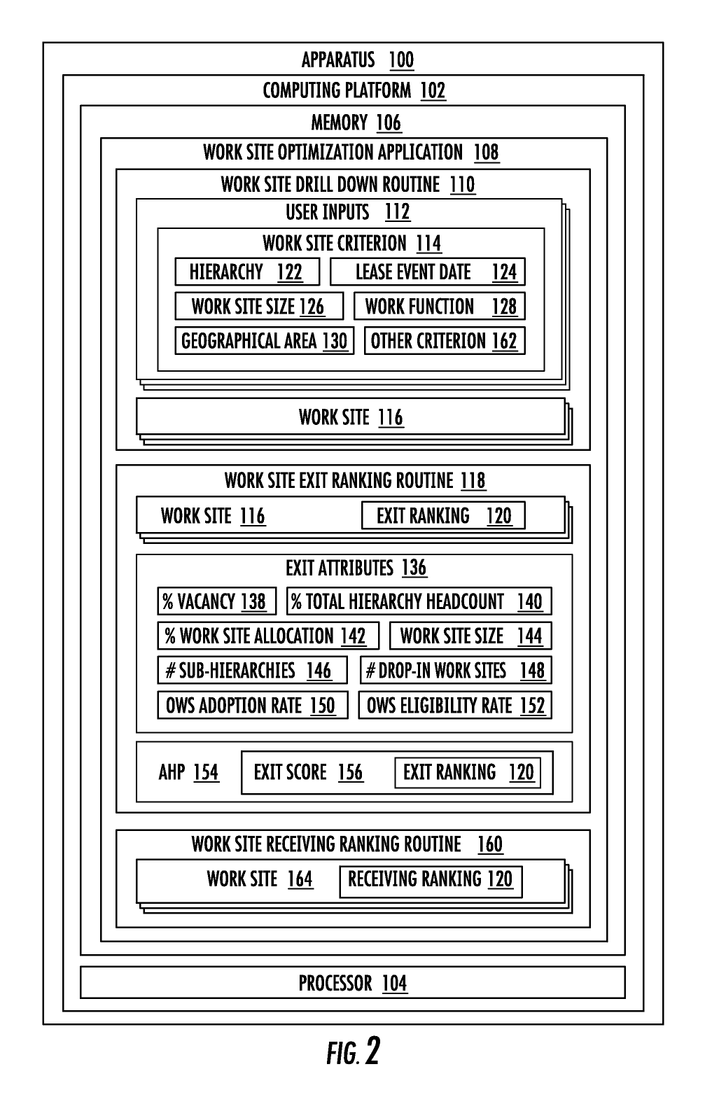

Referring to FIG. 2 a more detailed block diagram depiction of the apparatus 100, in accordance with an embodiment of the present invention. In addition to providing greater detail, FIG. 2 highlights various alternate embodiments of the invention. The apparatus 100 may include any type of one or more computerized, communication devices, such as a server, a personal computer, a portable computer, or any device or devices that include a computer platform 102 and have a wired and/or wireless connection to a network, such as the Internet, an intranet or the like.

The apparatus 102 includes computing platform 102 that can transmit data across a network, and that can receive and execute routines and applications. Computing platform 102 includes memory 106, which may comprise volatile and nonvolatile memory such as read-only and/or random-access memory (RAM and ROM), EPROM, EEPROM, flash cards, or any memory common to computing platforms. Further, memory 106 may include one or more flash memory cells, or may be any secondary or tertiary storage device, such as magnetic media, optical media, tape, or soft or hard disk.

Further, computing platform 102 also includes processor 104, which may be an application-specific integrated circuit (“ASIC”), or other chipset, processor, logic circuit, or other data processing device. Processor 104 or other processor such as ASIC may execute an application programming interface (“API”) layer (not shown in FIG. 2) that interfaces with any resident programs, such as work site optimization application 108 stored in the memory 106 of the apparatus 100.

Processor 106 includes various processing subsystems (not shown in FIG. 2) embodied in hardware, firmware, software, and combinations thereof, that enable the functionality of apparatus 100 and the operability of the apparatus 100 on a network. For example, processing subsystems allow for initiating and maintaining communications, and exchanging data, with other networked devices. For the disclosed embodiments, processing subsystems of processor 100 may include any subsystem used in conjunction with work site optimization application 108.

As previously noted, the memory 106 of apparatus 100 stores work site optimization application 108. Work site optimization application 108 includes work site drill down routine 110 that is configured to allow a user to define a subset of the overall work site population for subsequent work site optimization consideration. As such, work site drill down routine 110 is configured to receive one or more, and typically a plurality of, user inputs 112 that each define work site criterion 114. The work site criterion may include a business/entity hierarchy 122, a lease event date range 124, a work site size 126, an employee work function 128, a geographical area 130, or any other work site criterion 132.

The business/entity hierarchy 122 may be any segment or division of the business or entity. For example, the hierarchy 122 may be a line-of-business, or a level/sub-division within a line-of-business or the like.

A lease event date range 124 is a period of time, for example, a three month period (commonly referred to as a “quarter”) in which a critical event (i.e., lease event) associated with the lease occurs. The critical or lease event may be any contractual event, such as an early termination option, lease expiration or the like.

In specific embodiments of the invention, the work site size 126 may be defined in terms of work site size category. For example, work sites with less than 10,000 square feet may be defined as “small”, work sites with between 10,000 square feet and 50,000 square feet may be defines as “medium” and work sites with greater than 50,000 square feet may be defined as “large”. In such embodiments of the invention, the user input 112 may provide for choosing amongst a work site size category to identify the plurality of work sites to be considered for work site utilization optimization.

In other specific embodiments of the invention, the work function 128 defines a general work function category of the employees to be considered when identifying the plurality of work sites. In specific embodiments of the invention, the work function categories may include call center employees (i.e., employees required to work at a work site), core operations-mobile (i.e., employees that either are or may be off-work site employees), core operations-premise (i.e., operations managers required to work at a work site) and business support (i.e., all other employees).

In still further specific embodiments of the invention, the geographic area 130 may be defined by a standard metropolitan area, a mail/zip code, a region, a state or the like. As such, the user may provide inputs that select more than one metropolitan area, mail/zip code, region, state or the like.

Based on the work site criterion 114, a plurality of work sites 116 is identified. The plurality of work sites 116 is a subset of the overall work site population and form the group of work sites considered for work site utilization optimization.

Work site optimization application 108 additionally includes work site exit ranking routine 118 that is configured to determine an exit ranking 120 for each of the plurality work sites 116 identified in the work site drill down routine 110. In specific embodiments of the invention, the exit ranking 120 is relative to a feasibility to exit a work site and, more specifically, exit a lease associated with a work site.

In specific embodiments of the invention, the exit ranking 120 is based on a plurality of exit attributes 136 otherwise referred to as exit dimensions. The exit attributes 136 may include, but are not necessarily limited to, the percentage of vacancy for a work site 138; the total hierarchy-specific headcount 140; percentage of work site allocated to the hierarchy of interest 142; size of the work site 144; number of sub-hierarchies (e.g., line-of-business segment) occupying a work site 146; number of “drop-in” work sites (i.e., work sites that temporality accommodate off-work site employees) 148; adoption rate for eligible off-work site employees 150 and the eligibility rate for off-work site employees 152. It should be noted that the exit attributes 136 listed herein are by way of example only and that more or fewer exit attributes may be considered in determining the exit ranking 120. It is also noted that by including exit attributes that take into account the number “drop-in” work sites as well as the rate of eligible off-work site employees 152 and the rate at which off-work site eligible employees choose to work off-site (i.e., the off-work site adoption rate 150), present embodiments of the invention provide for the exit ranking 120 to be predictive in terms of the potential use of off-work site employees based on known eligibility and adoption rates.

In specific embodiments of the invention, the exit ranking 150 is based on an exit score 152 that is calculated by a weighted average of the plurality of exit attributes 136. In such embodiments of the invention, the weighting of the exit attributes may be based on the relative importance of each exit attribute in comparison to another exit attribute. Such pair-wise comparison of attributes may be performed according to an Analytical Hierarchy Process (AHP). See FIG. 10 for an example of an AHP matrix which may be used to assess relative exit attribute importance, in accordance with embodiments of the present invention.

In further embodiments of the invention, the work site optimization application 108 may include a work site receiving ranking routine 160 configured to determine a receiving ranking 162 for a plurality of work sites 164. The receiving ranking 162 ranks work sites in terms of their feasibility for receiving employees displaced from another work site being exited. In specific embodiments of the invention the receiving ranking 162 may be based on receiving attributes, such as, but not limited to, the vacancy at a potential receiving work site, the distance between a potential receiving work site and the exiting work site and the like.

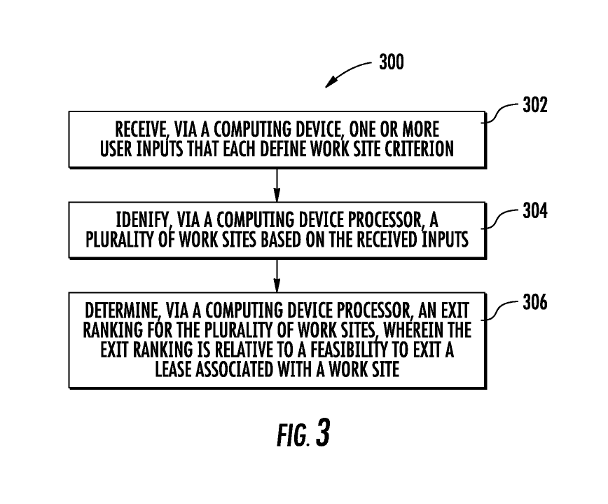

Turning the reader's attention to FIG. 3 a flow diagram is depicted of a method 300 for optimizing work site utilization within a business or other entity associated with work sites, in accordance with embodiments of the present invention. At Event 302, one or more user inputs are received that define work site criterion. As previously noted, the work site criterion may include, but is not limited to, a hierarchy within the business, a lease event data range, a work site size, a geographic area and/or a work function. At Event 304, a plurality of work sites is identified based on the received user inputs. The plurality of work sites is the identified subset of overall work sites from which an exit ranking is to be determined.

At Event 306, an exit ranking is determined for the plurality of identified work sites. The exit ranking is relative to a feasibility of exiting a work site and. in specific embodiments, the feasibility to exit a lease associated with a work site. In specific embodiments of the invention, determining the exit ranking further includes determining the exit ranking based on a plurality of exit attributes.

In specific embodiments the exit attributes take into account potential use of off-work-site employees. Such off-work site employee related exit attributes may include, but are not necessarily limited to, the number of “drop-in” work sites within a geographic area, the off-work site employee eligibility rate and the off-work site employee adoption rate. In such embodiments of the invention, in which the exit attributes rely on the potential use of off-work site employees, the exit ranking is characteristically predictive in nature.

In additional embodiments of the invention, the exit attributes may include, but are not necessarily limited to, the percentage of vacancy for a works site; size of the work site; percentage of the work site allocated to or controlled by the hierarchy; number of hierarchy segments within the work site and total number of employees within the hierarchy.

In further specific embodiments of the method, determining the exit ranking further includes determining an exit score that calculated based on a weighted average of the plurality of exit attributes. In such embodiments of the method, the weighted average may be determined based on a comparison of the relative importance between one exit attribute and another exit attribute. Such pair-wise comparison of attributes may be performed according to an Analytical Hierarchy Process (AHP).

In still further embodiments the method includes determining a receiving ranking for a plurality of work sites. The receiving ranking being relative to a feasibility of a work site to receive employees displaced from a work site being exited. In such embodiments of the method, determining the receiving ranking may further include determining the receiving ranking based on the vacancy at each of the plurality of work sites and the distance between the work sites and the exiting work site(s).

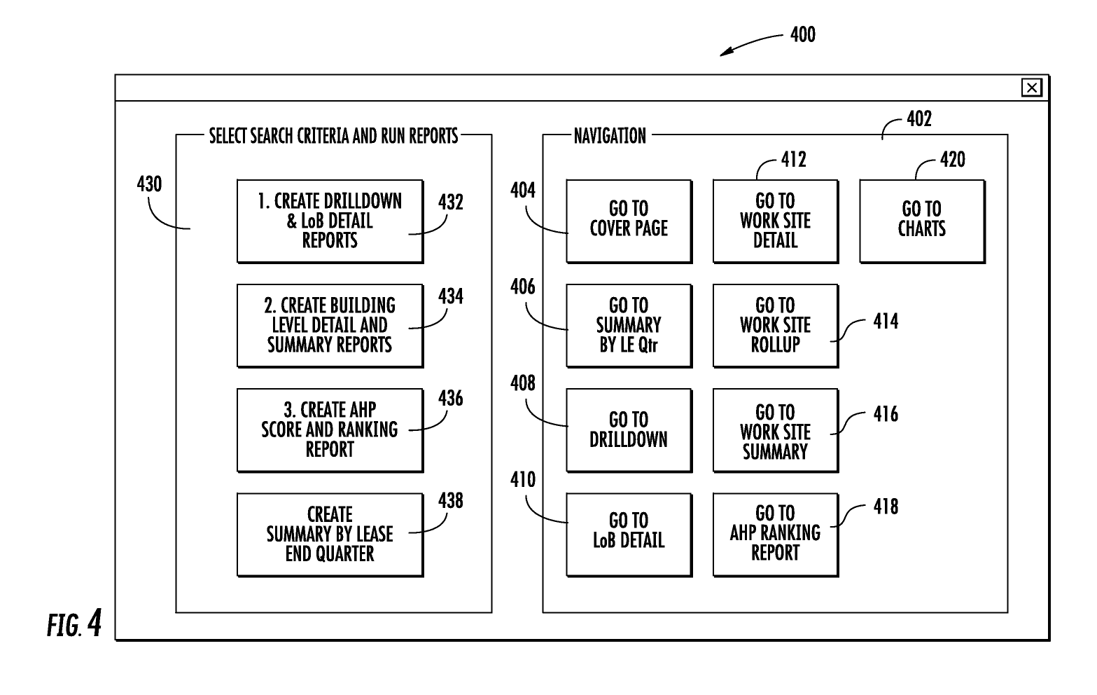

Referring to FIGS. 4-9 exemplary user interfaces implemented in a work site optimization application are shown, in accordance with embodiments of the present invention. The user interfaces provide for a user to input work site criterion to identity the plurality of work sites that are to subsequently exit ranked. It should be apparent that the user interfaces shown and described are by way of example only and, as such, the inventive concepts herein disclosed are not limited to such embodiments and/or such user interfaces.

FIG. 4 provides a user interface 400 configured to operate as a main navigation interface for a work optimization application, in accordance with embodiments of the present invention. User interface 400 includes a plurality of navigation icons 402, which upon user activation provides for displaying an associated feature of the work optimization application. For example, navigation icons 402 may include, but are not limited to, cover page 404, summary by lease event quarter 406, drill down 408, line-of-business detail 410, work site detail 412, work site rollup 414, work site summary 416, Analytical Hierarchy Process (AHP) exit ranking report 418 and charts 420.

Additionally, user interface 400 includes process icons 430, which upon user activation initiate steps in the work site optimization process, specifically inputting work site criterion, identifying a plurality of work sites, determining exit ranking for the identified work sites and generating associated reports, summaries and the like. Process icons include create drilldown and line-of-business (LoB) reports icon 432, create building level detail and summary reports icon 434, create AHP exit score and exit ranking report icon 436 and create summary by lease end quarter icon 438. It should be noted that creation of the AHP exit score and exit ranking report 436 can not be initiated prior to completing creation of building level detail and summary reports 434.

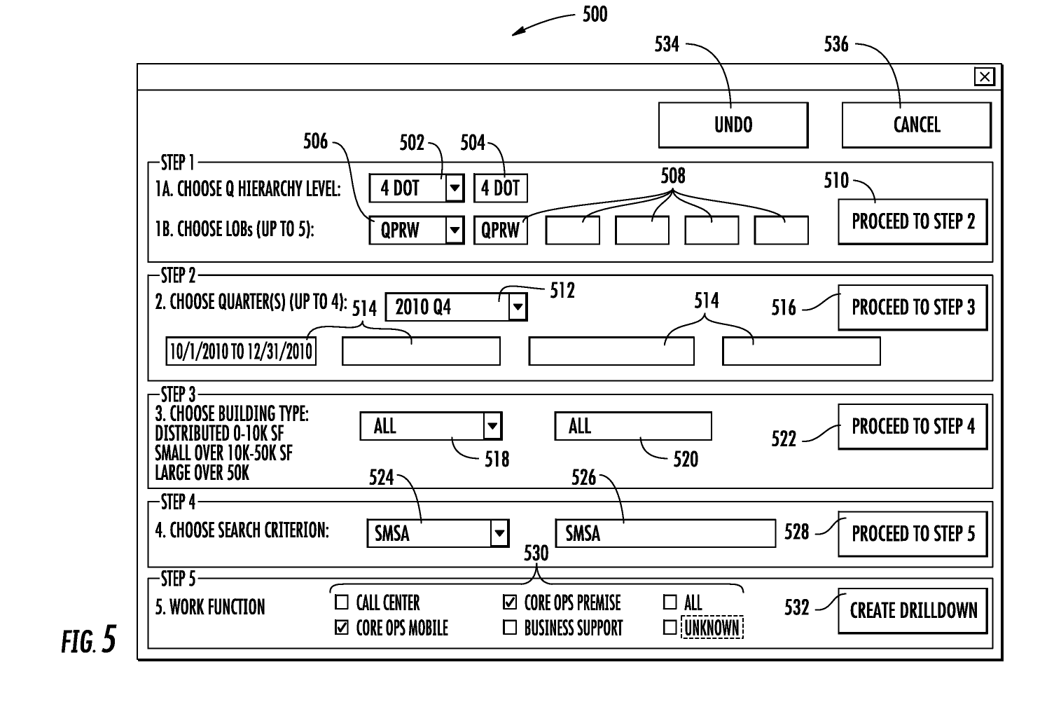

Based on a user activating the create drilldown and LoB reports icon 432 the user interface 500 shown in FIG. 5 is displayed. The user interface 500 provides for the user to input work site criterion as a means for drilling down to the desired work sites that meet the inputted criterion. The user interface 500 provides for step-wise progression for entering work site criterion. Additionally, the user interface provides for an “undo” icon 534 that upon activation cancels any selections made within a step, prior to saving the selections within a step (i.e., prior to activating the “proceed to step X” icon). Once the selections within a step have been saved, by activating the “proceed to step X” icon, the user may activate the “cancel” icon 536, which exits the user from the user interface 500, returns the user to user interface 400 and requires that the user re-initiate the create drilldown and LoB reports process (i.e., all previously saved work site criterion selections are deleted).

The first step in the process includes a user input that identifies the hierarchy level. Specifically, the user engages hierarchy drop down menu 502 to select a hierarchy. In the illustrated example, 2-dot, 3-dot and 4-dot represent different levels of hierarchy within the business, with 2-dot being the highest hierarchy level, which would include more employees, and 4-dot being the most specific hierarchy level, which would include less employees. However, it should be readily apparent that other businesses or entities will have other hierarchy indicators. In the illustrated example a user has chosen the 4-dot hierarchy level from the hierarchy drop down menu 502 and the chosen hierarchy is displayed in hierarchy window 504.

The first step in the process also includes a user input that identifies one or more lines-of-business. Specifically, the user engages line-of-business drop down menu 506 to select one, and up to five, lines-of-business. Additionally, the line-of-business drop down menu 506 may provide for selecting an “all” option from the drop-down menu 506, in which case all of the lines-of-business are considered in the identification of work sites (i.e., lines-of-business are not considered as a filter/work site criterion in the event “all” is selected). In the illustrated example a user has chosen a line-of-business abbreviated as “QPRW” from the line-of-business drop down menu 506 and the chosen lines-of-business are displayed in line-of-business windows 508. Once the user has inputted hierarchy level and line-of-business selections, the user activates the “proceed to step 2” icon 510, to save the selected work site criterion and initiate step 2 of the work site identification/drill down process.

The second step in the process includes a user input that identifies one or more 3-month periods, referred to as “quarters”, in which a lease event associated with a work site occurs. Specifically, the user engages quarter drop down menu 512 to select one, and up to four, quarters. Additionally, the quarter drop down menu 512 may provide for selecting an “all” option from the drop-down menu 512, in which case all of the quarters within a three year range are considered in the identification of work sites (i.e., the quarter in which a lease event occurs is not considered as a filter/work site criterion in the event “all” is selected). In the illustrated example a user has chosen the fourth quarter of 2010 from the quarter drop down menu 512 and the chosen quarter, represented as Oct. 1, 2010-Dec. 31, 2010 is displayed in quarter windows 514. Once the user has inputted lease event quarter selections, the user activates the “proceed to step 3” icon 516, to save the selected work site criterion and initiate step 3 of the work site identification/drill down process.

The third step in the process includes a user input that identifies the size of the work sites to be considered for exit ranking. Specifically, the user engages work site size drop down menu 518 to select a work site size. In the illustrated example, distributed indicates work sites with less than 10,000 square feet, small indicates work sites between 10,000 and 50,000 square feet and large indicates work sites. Additionally, the work site size drop down menu 518 may provide for selecting combinations of distributed, small and large or an “all” option from the drop-down menu 518, in which case all of the work site sizes are considered in the identification of work sites (i.e., work site size is not considered as a filter/work site criterion in the event “all” is selected). In the illustrated example a user has chosen the “all” option from the work site size drop down menu 518 and “all” is displayed in work site size window 520. Once the user has inputted a work site size selection, the user activates the “proceed to step 4” icon 522, to save the selected work site criterion and initiate step 4 of the work site identification/drill down process.

The fourth step in the process includes a user input that identifies a category of a geographical region/area to be considered for exit ranking Specifically, the user engages geographical drop down menu 524 to select a geographical category. In the illustrated example, the geographical categories in drop down menu 524 include Standard Metropolitan Statistical Area (SMSA), state and director region. The user may select one of the geographical categories from drop down menu 524 and be presented with further selection options associated with the geographic category. In the illustrated example, a user has chosen the SMSA option from the geographic area drop down menu 524 and SMSA is displayed in geographic area window 526.

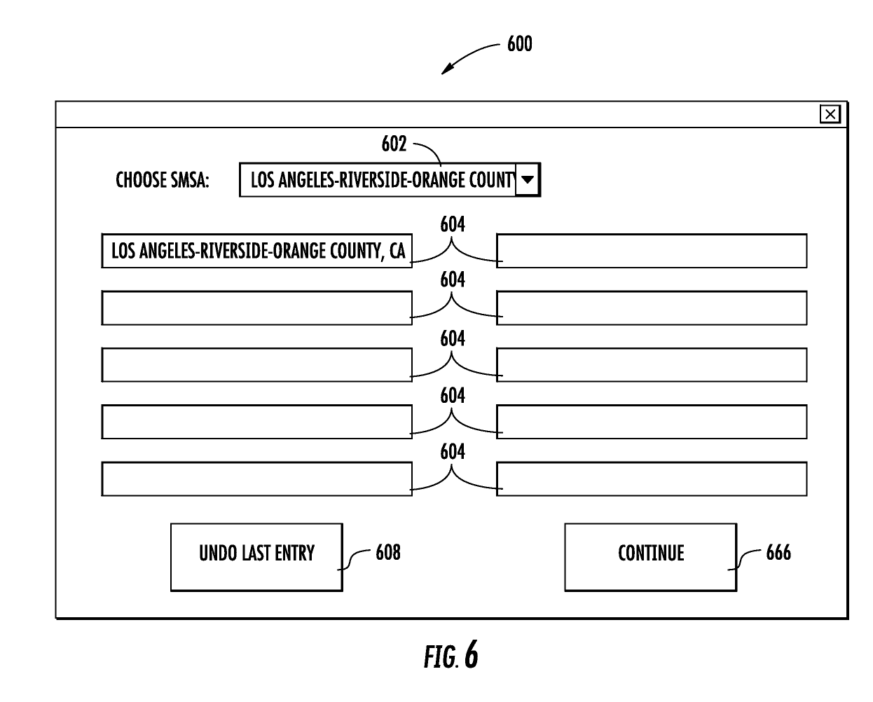

Once the user has inputted a geographic category selection, a user interface 600, as shown in FIG. 6 is displayed. The user interface 600 is configured to receive user inputs that define standard metropolitan areas. Likewise, if the user had chosen the state or director region as the geographic category, a user interface configured to receive user inputs that define states or director regions would be displayed. Specifically, the user engages SMSA down menu 602 to select one, and up to ten, standard metropolitan areas. In the illustrated example a user has chosen the Los Angeles-Riverside-Orange County, Ca SMSA from the SMSA drop down menu 602 and the chosen SMSA is displayed in SMSA windows 604. Once the user has inputted all of their SMSA selections, the user activates the “continue” icon 606 to return to the user interface 500, shown in FIG. 5. Alternatively, the user may activate the “undo last entry” icon 608 to undo the previously selected SMSA. Once the user is returned to user interface 500, the user activates the “proceed to step 5” icon 528, to save the selected work site criterion and initiate step 5 of the work site identification/drill down process.

The fifth step in the process includes a user input that identifies one or more work functions. Specifically, the user activates one or more work function option boxes 530 to select one or more work functions options. As shown, the work function options include, call center, core operations mobile, core operations premise, business support, all and unknown. In the illustrated example a user has chosen the core operations mobile and core operations premise work function options. In specific embodiments, if the user selects the all option (or if the application is configured such that the all option is the default option, absent a user selection), every work site is considered for exit ranking regardless of the work functions, including work sites having unknown work functions or work sites which do no include headcounts.

Once the user has inputted work function selections, the user activates the “create drill down” icon 532, to create a drill down report based on the inputted work site criterion. The drill down report includes drill down worksheets for each work site that meets the inputted work site criterion. The drill down worksheet includes various attributes related to the work site, such as, but not limited to, lease end quarter, property id, mail code, LOB hierarchy, work site size, work site description, location of work site, director region, allocated area to line-of-business, vacancy data, off-work site employee headcount, off-work site eligibility data, off-work site adoption rates and the like. In addition to generating drill down reports and/or drill down worksheets, a Line-of-Business (LOB) level detail report may be generated which combines drill down data based on combinations of lease event quarter, mail code, hierarchy level and or work functions.

Alternatively, the work site optimization application may configured to allow the user to forego re-running the drill down report at the mail code level and perform a predetermined function in connection with any range of mail code cells in the LOB level detail report. In such embodiments, the LOB level detail report may be configured as a spreadsheet, such as an Excel® spreadsheet, available from Microsoft Corporation, or the like. By performing the predetermined function (e.g., simultaneously activating the control and letter “q” keys) for any range of mail code cells selected, a drill down by mail code including data for all the work sites within the mail code cells selected is instantaneously created without duplication or omission of work sites. In addition to creation of a drill down work sheet, performing the predetermined function may additionally provide for automatic generation of building level detail reports and summary reports. Use of a predetermined function within the LOB level detail report can add efficiency to the generation of an optimization and allow the user to readily experiment with different temporal, geographical, etc., subsets of work locations, subsequently included (or excluded) in the work site scoring and work site ranking process.

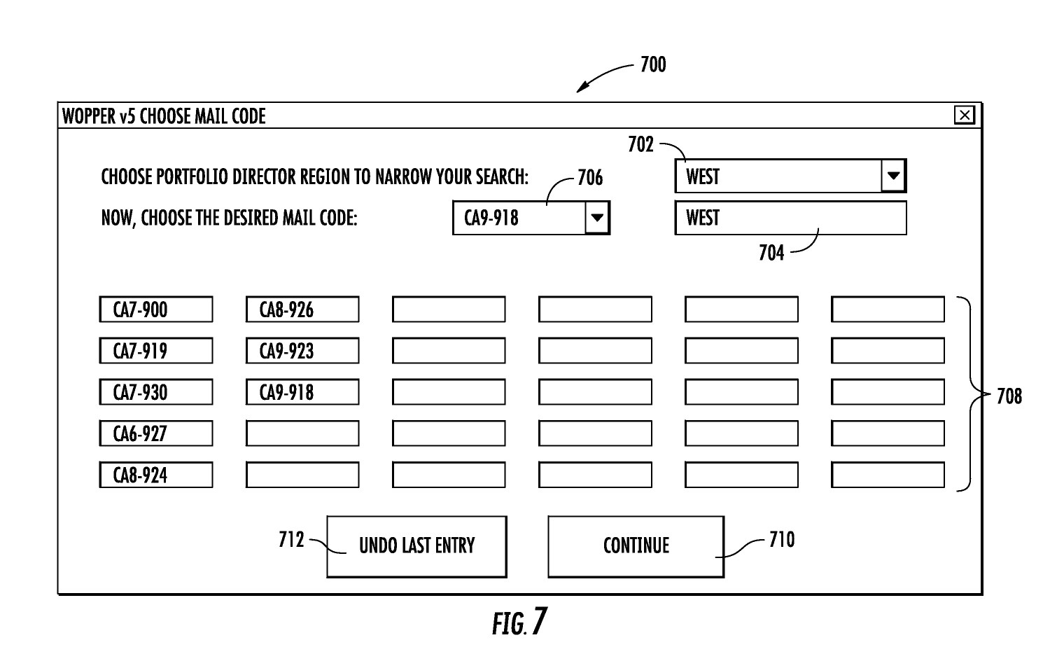

In addition to generating line-of-business level detail reports, the work site optimization application may additionally be configured to generate mail code level reports. In the user interface 500 of FIG. 5 the geographic category drop down menu 524 may be configured to include a mail code category. If in the first step, second and third steps of the drill down process the user selects “all” for hierarchy level, lease event quarter and building size and in step four selects the mail code category, user interface 700, as shown in FIG. 7, is displayed. User interface 700 is configured to receive user inputs that define director regions and/or mail codes. Specifically, the user engages director region down menu 702 to select a director region. In addition, to specific director regions drop down menu 702 may include an “all” option which provides for selecting all of the director regions. In the illustrated example a user has selected the “west” director region from the director region drop down menu 702 and the selected director region is displayed in director region window 704. Moreover, the user engages mail code down menu 706 to select one, and up to thirty, mail codes within the director region. In the illustrated example a user has selected eight mail codes from the mail code drop down menu 706 and the selected mail codes are displayed in mail code windows 708. The selected mail codes may reflect the mail codes of known work sites within a standard metropolitan region having a lease event occurring in a desired quarter. Once the user has inputted all of their mail code selections, the user activates the “continue” icon 710 to return to the user interface 500, shown in FIG. 5. Alternatively, the user may activate the “undo last entry” icon 712 to undo the previously selected director region or mail code. Once the user is returned to user interface 500, the user activates the “create drill down” icon 532, to create a drill down report organized and sorted by the eight inputted mail codes.

Once the line-of-business level and/or mail code level drill down reports have been created, the user may be returned to or navigate to user interface 400, as shown in FIG. 4. At this point, the user may select the create building level detail and summary report icon 434, which generates detail by mail code worksheets and summary by mail code worksheets. The detail by mail code worksheet and/or the summary by mail code worksheet includes all of the information necessary to calculate AHP attributes.

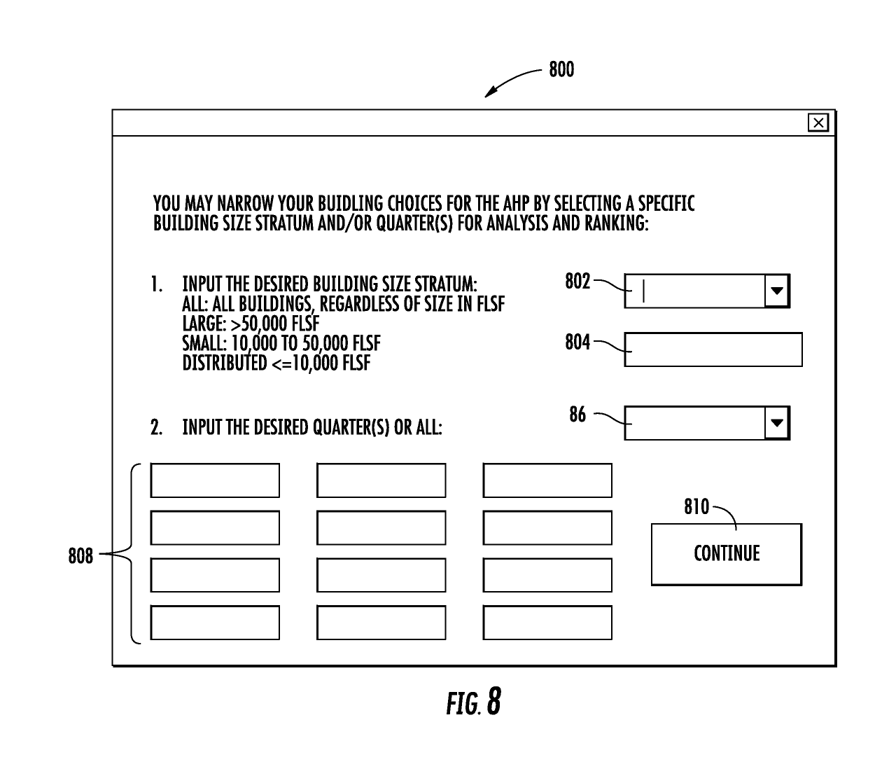

Once the user has generated drill down level reports (i.e., inputted work site criterion to identify a plurality of work sites), specifically, according to specific embodiments mail code level drill down reports, the user may activate the create AHP exit score and exit ranking report icon 436 of user interface 400. Upon activation of icon 436, user interface 800, shown in FIG. 8. is displayed. User interface 800 provides for narrowing the identified work sites to be included in the exit ranking, if the user desires to narrow the work sites included in the exit ranking. Based on the embodiment in which the AHP exit ranking is determined based on the mail code level drill down reports and the mail code level drill down reports designate “all” for building size and lease event quarter, further narrowing of the identified work sites may be accomplished by selecting a building size and/or a desired lease event quarter.

As such, user interface 800 includes building size drop down menu 802 which includes work site size categories. In the illustrated example, distributed indicates work sites with less than 10,000 square feet, small indicates work sites between 10,000 and 50,000 square feet and large indicates work sites. Additionally, the work site size drop down menu 518 may provide for selecting combinations of distributed, small and large or an “all” option from the drop-down menu 802, in which case all of the work site sizes are included in the AHP exit ranking. The selected building size is displayed in work site size window 804. User interface 800 additionally includes lease event quarter drop down menu 806 configured to allow selection of one, and up to twelve, lease event quarters. Additionally, the lease event quarter drop down menu 806 may provide for selecting an “all” option from the drop-down menu 806, in which case all of the quarters within a three year range are included in the AHP exit ranking. The selected lease event quarters are displayed in lease event quarter windows 808. Once the user has inputted building size and/or lease event quarter selections, the user activates the “continue” icon 810, to save the selected exit ranking narrowing selections and create an AHP exit ranking worksheet. The AHP exit ranking worksheet may include the work sites metrics for the exit attributes, as well as the exit score and the exit ranking. The exit score is based on weighted average of the exit attributes, in which the weighting is determined by making pair-wise importance comparisons of the exit attributes, in accordance with AHP processing. As previously noted, in specific embodiments the exit attributes may include, but are not necessarily limited to, percentage vacancy of the work site, percentage of work site allocated to the hierarchy of interest, size of the work site, number of “drop-in” work sites associated with a standard metropolitan area, the adoption rate for eligible off-work site employees, the number of hierarchy segments within a hierarchy, the off-work site eligibility rate and the total headcount within a hierarchy of interest.

Thus, methods, systems, computer programs and the like have been disclosed that provide for optimizing work site utilization within a business entity or the like. The automated, systematic and qualitative approach of the present invention provides for a more efficient means for work site reduction and consolidation decisioning, in which decisions can be made with limited management involvement and with the assurance that the most cost effective decision is being pursued. Additionally, the embodiments herein described account for the potential use of off-work site employees and, as such, the optimization rankings that are provided serve to predict future work site needs. In addition, the methods, systems and computer program products described herein are adaptable to any environment that may require work site reduction analysis, such as a merger environment, a highly volatile environment, a business-as-usual environment or the like.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for optimizing work site utilization within a business, the method comprising:
receiving, via a computing device, one or more user inputs that each define work site criterion;
identifying, via a computing device processor, a plurality of work sites based on the received inputs; and
determining, via a computing device processor, an exit ranking for the plurality of work sites, wherein the exit ranking is relative to a feasibility to exit a lease associated with a work site.

2. The method of claim 1, wherein receiving further comprises receiving, via the computing device, the one or more user inputs that each define work site criterion, wherein the work site criterion is one of (1) a hierarchy within the business, (2) a date range for occurrence of a lease event, (3) a work site size, (4) a geographical area or (5) an employee work function.

3. The method of claim 1, wherein determining further comprises determining, via the computing device processor, the exit ranking for the plurality of work sites, wherein the exit ranking is based on a plurality exit attributes.

4. The method of claim 3, wherein determining further comprises determining, via the computing device processor, the exit ranking for the plurality of work sites, wherein the exit ranking is based on the plurality exit attributes, wherein the exit attributes take into account potential use of off-work site employees.

5. The method of claim 4, wherein determining further comprises determining, via the computing device processor, the exit ranking for the plurality of work sites, wherein the exit ranking is based on the plurality exit attributes, wherein the exit attributes include one or more of (1) number of “drop-in” work sites within a geographical area, (2) off-work site employee adoption rate for a work site, or (3) off-work site employee eligibility rate for a work site.

6. The method of claim 3, wherein determining further comprises determining, via the computing device processor, the exit ranking for the plurality of work sites, wherein the exit ranking is based on the plurality of exit attributes, wherein the exit attributes include one or more of (1) percentage of work site allocation controlled by a hierarchy, (2) size of work site, (3) percentage of vacancy for a work site, (4) number of sub-hierarchies with a hierarchy for a work site, or (5) total employees for a hierarchy.

7. The method of claim 3, wherein determining further comprises determining, via the computing device processor, the exit ranking for the plurality of work sites, wherein the exit ranking is based on an exit score that is calculated by a weighted average of the plurality exit attributes.

8. The method of claim 7, wherein determining further comprises determining, via the computing device processor, the exit ranking for the plurality of work sites, wherein the exit ranking is based on the exit score that is calculated by the weighted average of the plurality exit attributes, wherein weighting is based on a comparison of importance between each pair of exit attributes.

9. The method of claim 8, further comprising determining, via a computing device processor, determining, via the computing device processor, the exit ranking for the plurality of work sites, wherein the exit ranking is based on the exit score that is calculated by the weighted average of the plurality exit attributes, wherein weighting is based on a comparison of importance between each pair of exit attributes, wherein the comparison is performed according to an Analytical Hierarchy Process (AHP).

10. The method of claim 1, further comprising determining, via a computing device processor, a receiving ranking for a plurality of work sites, wherein the receiving ranking is relative to feasibility of a work site to receive employees from an exit work site.

11. The method of claim 10, wherein determining the receiving ranking further comprises determining, via a computing device processor, the receiving ranking for the plurality of work sites, wherein the receiving ranking is based on vacancy at each of the plurality of work sites and distance between the plurality of work sites.

12. An apparatus for optimizing work site utilization within a business, the apparatus comprising:
a computing platform having at least one processor and a memory in communication with the processor, and
a work site optimization application stored in the memory, executable by the processor and including:
a work site drill down routine configured to receive one or more user inputs that each define work site criterion and identify a plurality of work sites based on the received inputs, and
a work site exit ranking routine configured to determine an exit ranking for the plurality of work sites, wherein the exit ranking is relative to a feasibility to exit a lease associated with a work site.

13. The apparatus of claim 12, wherein the work site drill down routine is further configured to receive the one or more user inputs that each define work site criterion, wherein the work site criterion is one of (1) a hierarchy within the business, (2) a date range for occurrence of a lease event, (3) a work site size, (4) a geographical area or (5) an employee work function.

14. The apparatus of claim 12, wherein the work site exit ranking routine is further configured to determine the exit ranking for the plurality of work sites, wherein the exit ranking is based on a plurality exit attributes.

15. The apparatus of claim 14, wherein the work site exit ranking routine is further configured to determine the exit ranking for the plurality of work sites, wherein the exit ranking is based on the plurality exit attributes, wherein the exit attributes take into account potential use of off-work site employees.

16. The apparatus of claim 15, wherein the work site exit ranking routine is further configured to determine the exit ranking for the plurality of work sites, wherein the exit ranking is based on the plurality exit attributes, wherein the exit attributes include one or more of (1) number of “drop-in” work sites within a geographical area, (2) off-work site employee adoption rate for a work site or (3) off-work site employee eligibility rate for a work site.

17. The apparatus of claim 14, wherein the work site exit ranking routine is further configured to determine the exit ranking for the plurality of work sites, wherein the exit ranking is based on the plurality of exit attributes, wherein the exit attributes include one or more of (1) percentage of work site allocation controlled by a hierarchy, (2) size of a work site, (3) percentage of vacancy for a work site, (4) number of sub-hierarchies with a hierarchy for a work site, or (5) total employees for a hierarchy.

18. The apparatus of claim 14, wherein the work site exit ranking routine is further configured to determine the exit ranking for the plurality of work sites, wherein the exit ranking is based on an exit score that is calculated by a weighted average of the plurality of exit attributes.

19. The apparatus of claim 18, wherein the work site exit ranking routine is further configured to determine the exit ranking for the plurality of work sites, wherein the exit ranking is based on the exit score that is calculated by the weighted average of the plurality exit attributes, wherein weighting is based on a comparison of importance between each pair of exit attributes.

20. The apparatus of claim 19, wherein the work site exit ranking routine is further configured to determine the exit ranking for the plurality of work sites, wherein the exit ranking is based on the exit score that is calculated by the weighted average of the plurality exit attributes, wherein weighting is based on a comparison of importance between each pair of exit attributes, wherein the comparison is performed according to an Analytical Hierarchy Process (AHP).

21. The apparatus of claim 19, wherein the work site optimization application further includes a work site receiving ranking routine configured to determine a receiving ranking for a plurality of work sites, wherein the receiving ranking is relative to a feasibility of a work site to receive employees from an exit work site.

22. The apparatus of claim 21, wherein the work site receiving ranking routine is further configured to determine the receiving ranking for the plurality of work sites, wherein the receiving ranking is based on vacancy at each of the plurality of work sites and distance between the plurality of work sites.

23. A computer program product, comprising:
a non-transitory computer-readable medium comprising:
a first set of codes for causing a computer to receive one or more user inputs that each define work site criterion;
a second set of codes for causing a computer to identify a plurality of work sites based on the received inputs; and
a third set of codes for causing a computer to determine an exit ranking for the plurality of work sites, wherein the exit ranking is relative to a feasibility to exit a lease associated with a work site.

24. The computer program product of claim 23, wherein the first set of codes is further configured to cause the computer to receive the one or more user inputs that each define work site criterion, wherein the work site criterion is one of (1) a hierarchy within the business, (2) a date range for occurrence of a lease event, (3) a work site size, (4) a geographical area or (5) an employee work function.

25. The computer program product of claim 23, wherein the third set of codes is further configured to cause the computer to determine the exit ranking for the plurality of work sites, wherein the exit ranking is based on a plurality exit attributes.

26. The computer program product of claim 25, wherein the third set of codes is further configured to cause the computer to determine the exit ranking for the plurality of work sites, wherein the exit ranking is based on the plurality exit attributes, wherein the exit attributes take into account potential use of off-work site employees.

27. The computer program product of claim 26, wherein the third set of codes is further configured to cause the computer to determine the exit ranking for the plurality of work sites, wherein the exit ranking is based on the plurality exit attributes, wherein the exit attributes include one or more of (1) number of “drop-in” work sites within a geographical area, (2) off-work site employee adoption rate for a work site, or (3) off-work site employee eligibility rate for a work site.

28. The computer program product of claim 25, wherein the third set of codes is further configured to cause the computer to determine the exit ranking for the plurality of work sites, wherein the exit ranking is based on the plurality of exit attributes, wherein the exit attributes include one or more of (1) percentage of work site allocation controlled by a hierarchy, (2) size of work site, (3) percentage of vacancy for a work site, (4) number of sub-hierarchies with a hierarchy for a work site, or (5) total employees for a hierarchy.

29. The computer program product of claim 25, wherein the third set of codes is further configured to cause the computer to determine the exit ranking for the plurality of work sites, wherein the exit ranking is based on an exit score that is calculated by a weighted average of the plurality exit attributes.

30. The computer program product of claim 29, wherein the third set of codes is further configured to cause the computer to determine the exit ranking for the plurality of work sites, wherein the exit ranking is based on the exit score that is calculated by the weighted average of the plurality exit attributes, wherein weighting is based on a comparison of importance between each pair of exit attributes.

31. The computer program product of claim 30, wherein the third set of codes is further configured to cause the computer to determine the exit ranking for the plurality of work sites, wherein the exit ranking is based on the exit score that is calculated by the weighted average of the plurality exit attributes, wherein weighting is based on a comparison of importance between each pair of exit attributes, wherein the comparison is performed according to an Analytical Hierarchy Process (AHP).

32. The computer program product of claim 23, further comprising a fourth set of codes for causing a computer to determine a receiving ranking for a plurality of work sites, wherein the receiving ranking is relative to feasibility of a work site to receive employees from an exit work site.

33. The computer program product of claim 32, wherein the fourth set of codes is further configured to cause the computer to determine the receiving ranking for the plurality of work sites, wherein the receiving ranking is based on vacancy at each of the plurality of work sites and distance between the plurality of work sites.
